(19) United States
(12) Patent Application Publication
(10) Pub. No.: US 2023/0134496 A1
(43) Pub. Date: May 4, 2023

(54) FLOOR PANEL HAVING MAGNETIC ADHESION, AND FLOOR COVERING

(71) Applicants: Tomas DELLA PEPA, Mutterstadt (DE); Hans MEYER, Ludwigshafen (DE); FLIESEN INNOVATIONS GBR, MUTTERSTADT (DE)

(72) Inventor: Tomas DELLA PEPA, Mutterstadt (DE)

(73) Assignee: FLIESEN INNOVATIONS GBR, MUTTERSTADT (DE)

(21) Appl. No.: 17/432,415

(22) PCT Filed: Feb. 19, 2020
(86) PCT No.: PCT/DE2020/100119

§ 371 Date: Aug. 19, 2021

(30) Foreign Application Priority Data
Feb. 19, 2019 (DE) 10 2019 202 246.4

(51) Int. Cl. E04F 15/02; E04F 15/08; E04F 15/18; B32B 3/06; B32B 7/12

(52) U.S. Cl. CPC E04F 15/02144; E04F 15/02016; E04F 15/082; E04F 15/18; B32B 3/06; B32B 7/12; B32B 5/18

(57) ABSTRACT

A floor panel (2) of a floor covering (1), which forms a walkable surface (1.1) of the floor covering (1) by laterally placing several floor panels (2) on top of each other, has the dimensions length and width, and a magnetic layer (4) is arranged on an underside (2.2) of the floor panel (2). The magnetic layer (4) extends over at least 90% of each of the two dimensions length and width of the underside (2.2) of the floor panel (2) at least partially and covers at least a total area of 25% of the underside (2.2), preferably at least 50%, and particularly preferably at least 85%.

A floor covering (1) is formed by a floor panel (2) and a magnetic support (5).

### TECHNICAL AREA

The invention relates to a floor panel and a floor covering, comprising a floor panel with magnetic adhesion on a support structure.

### STATE OF THE ART

DE 196 06 341 C2 describes a floor construction system for the manufacture of floors, in which a support element has a magnetized upper surface. At least partially continuous recesses are made in the support layer floor in which a magnetic tape is inserted. A plastic coating filled with ferrite or the like may be arranged on the underside of the top cover. Since the top layer is not firmly bonded to the base layer floor by gluing or the like, it is possible to replace the top layer in a very short time.

A raised floor system is known from DE 20 2013 102 956 U1, in which a floor panel has at least one magnetic tape for fixing to a supporting structure, the magnetic tape running in an edge region of the floor panel. The magnetic tape can be at least partially accommodated in the floor panel, in particular flush with its surface.

Furthermore, a groove and/or a tongue may be provided at least partially on the circumferential edge of the floor panel. This floor covering is intended to allow easy assembly or disassembly as well as alignment of the floor covering to a supporting structure before it is possibly additionally bolted to the supporting structure or fixed thereto by positioning bolts. In addition to the magnetic strips at the top, frames can also have magnetic strips on their lateral surface, via which a vertical facing can be fixed.

The magnetic connection via magnetic tapes described in the prior art requires a specially adapted base layer in which the tapes are embedded. If the tapes are not embedded, the result is only punctual support, which has a negative effect on the strength of the floor panel.

On the other hand, the production of a conventional floor covering made of tiles, especially ceramic tiles, usually requires one day for bonding, one day for leveling and one day for grouting.

The object of the invention is to produce a floor covering in which the floor panel rests substantially over the entire surface on a support structure and is connected thereto in a strength-increasing manner.

### REPRESENTATION OF THE INVENTION

In a floor panel of a floor covering according to the invention, in particular for laying decoupled from a floor, which floor panels form a walkable surface of the floor covering by laying a plurality of floor panels laterally against one another, the floor panel having the dimensions length and width, and a magnetic layer being arranged on an underside of the floor panel, the magnetic layer extends over at least 90% of each of the two dimensions length and width of the underside of the floor panel at least over part of the surface and covers at least a total area of 25% of the underside, preferably at least 50%, and particularly preferably at least 85%.

This allows the floor panel to be attached to a support in a sufficient length and over a sufficient area, and can rest on and be connected to that support.

The invention allows floor tiles, in particular ceramic tiles, to be laid without having to level the resulting floor covering, since the floor tiles rest in a defined manner with their magnetic layer on the support. In other words, unlike in classic tiling, there is no adhesive layer centrally under the floor tiles that still has to harden, so that no separate leveling of the floor covering is required.

Advantageously, the magnetic layer can be full-surface. Full-surface means that there are no material interruptions in the two dimensions. Partial-surface means that material interruptions with dimensions in the two dimensions, such as through-holes or punch-outs, may be present. A grid or mesh is also to be understood as partial-surface, likewise a screen plate. Furthermore, an arrangement of parallel strips or individual arbitrary discs or partial areas with an intervening distance is to be understood as partial-surface, also an arrangement of concentric rings with increasing diameter, which are spaced apart from each other and may be connected to each other by webs, are to be understood as partial-surface.

The distribution of the magnetic layer on the underside of the floor panel should be such that the compressive forces acting on the floor panel from the upper side are distributed sufficiently evenly. This can be achieved, for example, by an even distribution of the areas with magnetic layer and the areas without magnetic layer on the underside of the floor panel. A sufficient proportion of the magnetic layer must also be provided in the central area of the floor panel. The proportion of magnetic layer depends on the load to be absorbed and the desired magnetic force of the magnetic layer.

Advantageously, the magnetic layer can be set back laterally relative to a side edge of the floor panel so that there is a distance from the side edge and the underside of the floor panel is uncovered by the magnetic layer over this distance.

During installation, a joint can then be provided through which a tile adhesive can also reach the underside of the floor panel and additionally bond the floor panel to the support.

In this respect, the magnetic layer is preferably laterally recessed with respect to each side edge of the floor panel.

This allows stable bonding of the floor panels to the support without significant drying times, since the adhesive is only present in the edge area of the floor panels. Furthermore, leveling of the floor covering is not required, since the floor panels rest on the support with their magnetic layer without an adhesive layer formed underneath. This means that laying and automatic leveling can be carried out in a single step.

In this case, the distance of the magnetic layer, i.e. the edge of the magnetic layer, from the side edge of the floor panel can be between 3-10 mm, and in particular about 5 mm.

When laying the floor panels, especially as tiles, a joint width between two adjacent floor panels of approx. 3 mm is preferred.

Furthermore, the magnetic layer can have a thickness of at least 0.5 to a maximum of 3 mm and a Shore D hardness according to DIN ISO 7619-1 issue 2-2012 of harder than 50 Shore D 3s.

Here, a magnetic layer may be formed in the form of a magnetic sheet, and the magnetic sheet may be made of chlorinated polyethylene (CPE) to which magnetic powder has been added.

Advantageously, the magnetic layer can be a magnetic foil, and the magnetic foil can be self-adhesive or attached to the underside of the floor panel by means of an adhesive. This means that non-self-adhesive magnetic foils can also be used.

Advantageously, the magnetic foil can be magnetic on one side only and the non-magnetic side can be arranged towards the floor panel. Such foils are less expensive than foils that are magnetic on both sides.

Advantageously, the magnetic layer can be formed from a cured compound, which can still be shaped before curing, by application to the underside. The application can be carried out, for example, by printing, or applied via a stencil with a squeegee, over the entire surface or over part of the surface in a variety of arrangements. In particular, this allows a wide range of geometries of the partial areas with only partial-surface application.

The floor panel is preferably a tile, particularly preferably a ceramic tile.

Another object of the invention is a floor covering comprising a floor panel according to the invention and a support on which the floor panel rests. The support has a magnetic material which interacts with the magnetic layer of the floor panel. The magnetic material of the support is formed by an at least partial pressure distribution panel, which is connected to a plastically or elastically deformable leveling layer, and at least partially covers the latter.

Both as “magnetic layer” of the floor panel and as “magnetic material” of the support are understood in the context of the invention in each case optionally an element with or made of a permanent magnet or also an element with or made of a ferrimagnetic or ferromagnetic material. A magnetic attraction between a first magnetic element and a second magnetic element as understood in the invention includes both the attraction between two permanent magnets and the attraction between a permanent magnet and an element made of a ferrimagnetic or ferromagnetic material.

In particular, the pressure distribution panel can be or have an at least partially magnetic sheet.

Alternatively or additionally, the pressure distribution panel may comprise a panel of plastic or cement fiber, a high-density fiberboard (HDF), a medium-density fiberboard (MDF), or a combination or composite of at least two thereof.

Such flooring can be laid on the floor without any further supporting support structure, without being connected to the floor. This allows for quick installation and removal.

Special preparation of the floor is generally not required, as any unevenness will be compensated for by the leveling layer provided. The installation of the floor panels on the support, on the other hand, is then automatically carried out at the same height level without the need for leveling here.

Advantageously, the pressure distribution panel can be an at least partial-surface plate, in particular sheet metal, with a total area of at least 50% of the total area of the leveling layer, and can cover the leveling layer correspondingly to at least 50%, preferably to at least 70%, and particularly preferably to at least 85%.

Here, too, it must be ensured that the cover is sufficient to absorb the forces to be expected during the intended use. A full-surface plate has the advantage of increased stability, a partial-surface plate the advantage of weight savings.

Advantageously, the pressure distribution panel can be full-surface and completely cover the leveling layer.

Advantageously, the leveling layer can be bonded to the pressure distribution panel by means of an adhesive, in particular as a magnetic sheet.

Advantageously, the pressure distribution panel can have an area that is at least 1.5 times the area of the top of the floor panel. This allows the support to be laid out over a large area without having to take into account the smaller division of the floor panel.

In general, it must be taken into account that the joints of the floor panels must be laid offset to the joints of the pressure distribution slabs.

The floor panel, especially as a tile, or the end covering can be made of ceramic, natural stone, cork, wood, textile (carpet), glass or any other material. A PU or an epoxy adhesive, for example, can be used as the adhesive layer.

The thickness of the magnetic foil is preferably between 0.5 and 3 mm, with the magnetic thickness preferably resulting in an adhesive force of at least 50 g/cm². This adhesive force is ensured over the entire upper side of the floor panel intended for use as an average value. In particular, a magnetic foil is suitable which is magnetized at least on one side, namely on the side intended for use facing away from the surface of the floor panel.

In a floor panel system constructed in this way, a floor panel is placed on a pressure distribution panel, in particular on a magnetizable sheet acting as such, whereby a thickness of 0.75 mm has been found to be particularly suitable for the sheet in the case of a galvanized steel sheet, taking into account the technical properties and economy. A greater thickness leads to a higher load capacity of the floor covering, but at a higher cost.

The pressure distribution panel, in particular as a magnetizable sheet, is connected to a leveling layer, for example by means of an adhesive, to compensate for an uneven floor. This leveling layer can be a PU foam, polystyrene, a fleece or another material, with a plastic or an elastic deformability to compensate for unevenness in the floor to be covered.

The pressure distribution panel, in particular the magnetizable sheet, with the leveling layer distributes point loads acting on the floor panel over a larger area and is thus intended to prevent the floor panel from breaking.

To attach a joint profile, the magnetic layer can be set back relative to the side edge of the floor panel, so that a T-profile known per se can be pushed inverted under one side edge and the next floor panel covers the other part of the T-profile. The contact pressure of the magnetic layer on the pressure distribution panel, in particular the magnetizable sheet, creates a pretension in the T-section, so that a seal can also be created here under certain circumstances if the T-section is designed accordingly.

Instead of a T-profile, a joint set by means of spacers between the panels can also be grouted, for example with epoxy resin.

Furthermore, a liner can be provided on the side edges, for example as an impact-resistant edge made of a material such as ABS, which absorbs impacts without damaging the floor panel.

Such an edge protector can also be designed as a tongue-and-groove joint to provide stabilization via the side edge. This is known in the prior art.

It is also possible to provide a base on such a floor covering, whereby an angle profile is arranged in the area of the leveling layer, but possibly also in the area between the floor covering and the pressure distribution panel, in particular as a magnetizable sheet, which either presses into the leveling layer, or which is clamped between the floor covering and the magnetizable sheet like the T-profile.

On the free leg of the angle section, which may be formed from a magnetizable sheet, a base panel with a magnetic layer extending above the floor panel may in turn be arranged.

The pressure distribution panel, in particular made of magnetizable sheet metal, with the leveling layer can be provided and laid in a large blank, for example as plates of 80×120 cm or larger, i.e. possibly a multiple of the dimension of the floor panels to be laid later, which may have a dimension of 30×20 cm, 40×60 cm or similar.

The floor covering is preferably produced by laying the pressure distribution panels provided with the leveling layer in a large-area denomination centrally in the room, accepting that edge strips not covered by this pressure distribution panel remain at the edges. These can be filled, for example, with cork plates of the same thickness, which can be cut to size by the simplest of means, such as scissors. Of course, it is also possible to provide pressure distribution panels of different widths and lengths in order to reduce the number of missing areas when they are laid out in a mediated manner, i.e., starting in the middle of the room instead of from one side.

With the laying of the pressure distribution panels, any angle profiles for the attachment of base panels can also be inserted.

If the floor panels are laid out in a mediated manner, the angle profile may not lie under the pressure distribution panels. In this case, the angle profile presses into the edge strip.

The subject matter of the patent also includes a complete floor in a building, since this floor is fully removable and need not be connected to the building in any way.

For the sake of completeness, it is pointed out that the magnetic foil is thermally stable up to 80-90° C. and is permanently magnetized. Permanently magnetized here means that the magnetic force is maintained, which is particularly the case if the floor covering is not repeatedly loosened and relaid. In practical operation, constant loosening and re-laying is not to be expected. When the magnetic force of a floor tile decreases, it can be replaced.

Loss of magnetic force can also be compensated for by either remagnetizing or removing the old magnetic layer and applying a new magnetic layer.

### BRIEF DESCRIPTION OF THE DRAWING

The drawing shows an example of an embodiment of the invention. It shows:

FIG. 1 a section of a floor covering with a floor panel;

FIG. 2 the function of a leveling layer in the floor covering;

FIG. 3 the use of an angle profile for fastening a base panel to a wall;

FIG. 4 a known connection profile in the form of an inverted letter T

FIG. 5 a version with an edge strip;

FIG. 6 a perspective view of a floor covering laid out in a room;

FIG. 7 a floor panel with an assembly aid in the form of a joint angle,

FIG. 8 The joint angle from FIG. 7 in detail;

FIG. 9 The joint angle from FIG. 8 in section.

### DESCRIPTION OF EMBODIMENTS

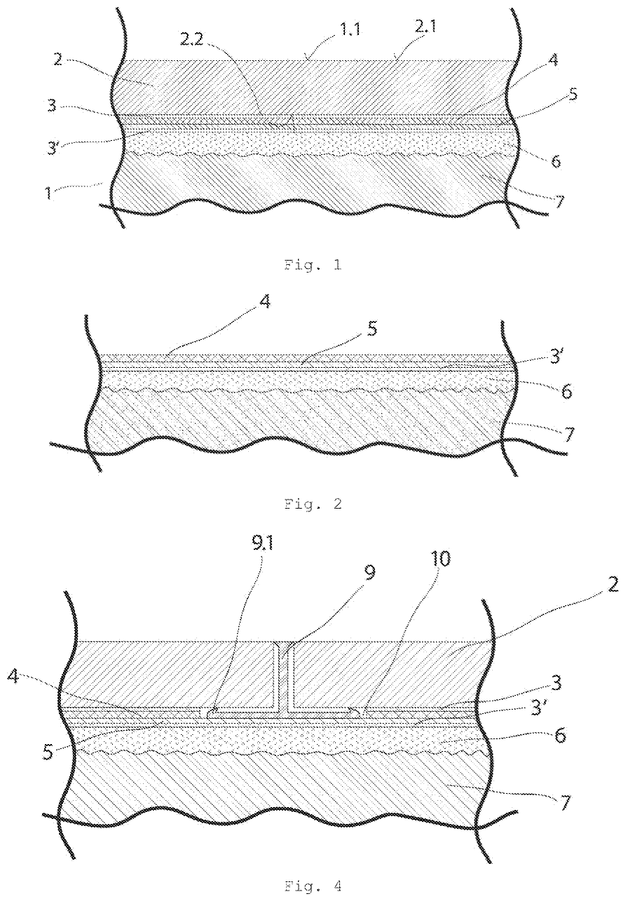

FIG. 1 shows a section of a floor covering 1, which has a floor panel 2 with an upper side 2.1, wherein a walkable surface 1.1 of the floor covering 1 is provided by placing a plurality of floor panels 2 side by side. The floor panel 2 has the dimensions length and width, which are explained below.

A magnetic layer 4 attached with an adhesive 3 is arranged on an underside 2.2 of the floor panel 2 opposite the upper side 2.1. Instead of an adhesive layer, the magnetic layer 4 can be laminated to the underside 2.2 of the floor panel 2, but this is not shown.

The magnetic layer 4 shown extends over the entire surface under the floor panel 2, which is also full-surface, i.e. it has no interruptions.

In this case, the magnetic layer 4 is a magnetic foil with a thickness of at least 0.5 to at most 3 mm and has a Shore D hardness according to DIN ISO 7619-1 issue 2-2012 of harder than 50 Shore D measuring time 3 s, in the present case of 43 Shore D+/−5.

The magnetic foil is isotropic, i.e. it deforms uniformly in all directions under pressure.

It is sufficient if the magnetic foil is magnetic on one side only. In this case, the non-magnetic side of the magnetic foil is arranged towards the underside 2.2 of the floor panel 2.

The floor covering 1 further comprises a support 5 designed for pressure distribution, on which the floor panel 2 rests by means of the magnetic layer 4. The support 5 has a magnetic material, which is in particular an at least partial-surface, magnetic pressure distribution panel. The magnetic material of the support 5, in particular the pressure distribution panel, consists in particular of a galvanized steel sheet which interacts with the magnetic layer 4 of the floor panel 2 and is in frictional contact with the latter. Pressure is distributed from the floor panel 2 to a base 7 via the support 5.

A galvanized steel sheet is a steel sheet that is usually galvanized against rust and weather influences. In this process, a thin layer of zinc is permanently applied to the sheet.

The magnetic steel sheet is formed over the entire surface and is bonded to and completely covers a plastically or elastically deformable leveling layer 6 via an adhesive 3′. The leveling layer 6 rests on the floor 7.

FIG. 2 shows the function of the leveling layer 6. In the case of an uneven floor 7, the unevenness of the floor presses into the leveling layer 6 and deforms it elastically or plastically, so that its thickness changes locally. The adhesive layer 3′ and the support 5, on the other hand, remain largely undeformed, so that the magnetic layer 4, which is shown without the floor panel 2 and the adhesive 3 from FIG. 1, lies flat.

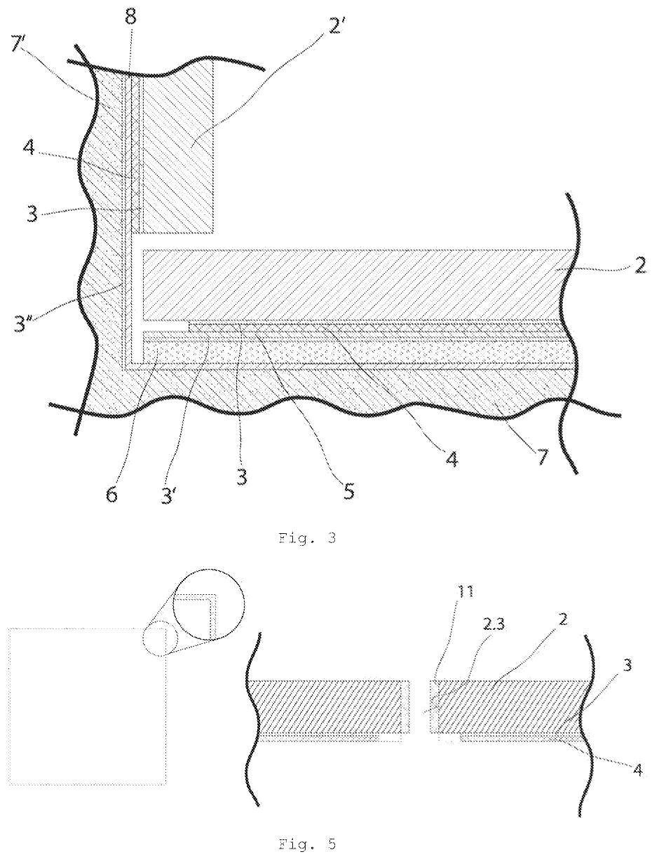

FIG. 3 shows the use of an angle profile 8 which projects below the leveling layer 6 and is connected alternatively or additionally via an adhesive 3″ to a wall 7′ extending upwards over the floor 7. This angle profile 8 is also at least partially magnetic, so that a base panel 2′ is attached to the wall 7′ via a magnetic foil 4 fixed by means of an adhesive 3.

An existing joint between the base panel 2′ and the floor panel 2 may be sealed and/or fixed with a joint material, and the upper edge, which is not shown, may also be sealed and/or fixed with a joint material. Thus, in addition to the magnetic connection, another fixed connection can be provided.

FIG. 4 shows a connecting profile 9 known from WO 2012/117074 A2 in the form of an inverted letter T, which is inserted between two adjacently arranged floor panels 2. As a result of the fact that the magnetic layer 4 and the adhesive 3 are recessed in the edge region of the floor panel 2, a gap 10 is created when the floor panel 2 is placed on the support 5, into which the connecting profile 9 is inserted and can also be clamped because of the force-locking connection of the floor panel 2 to the support 5.

When the connecting profile 9 is force-fitted into the gap 10, sealing lips 9.1 may be arranged at the ends of the transverse bar of the inverted letter T to seal a joint between two adjacent panels 2.

Since the floor panel 2 is smaller than the support 5 and independent of the latter in size, the support 5 in the example shown extends under both adjacent floor panels 2, and the connecting profile 9 rests on the support 5. The support 5 itself is connected to the leveling layer 6, which rests on the floor 7 and compensates for unevenness of the floor, via an adhesive 3′, as already explained in the previous Figs.

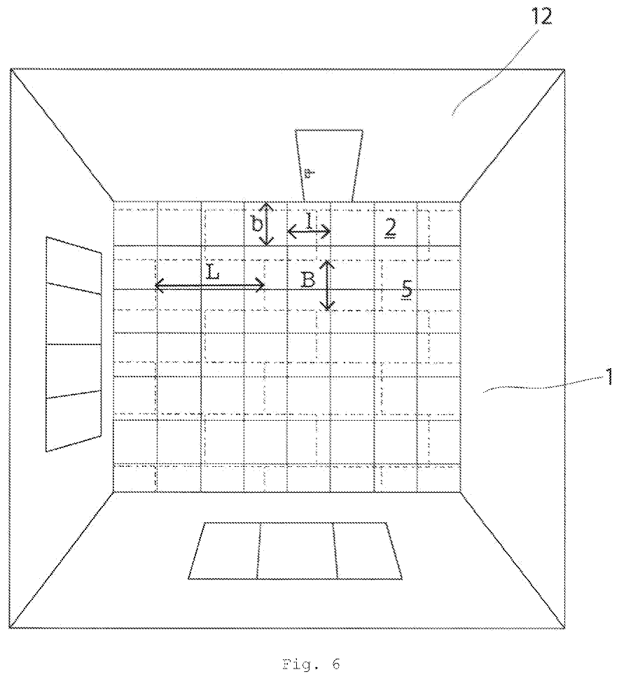

FIG. 5 shows an embodiment with an edge strip 11 arranged on a side surface 2.3 of the floor panel 2. Here, too, the magnetic layer 4 with the adhesive 3 can be set back relative to the side surface 2.3. A joint formed between adjacent floor panels 2 may be filled with a flowable, curing joint material, for example an epoxy adhesive or the like, and the joint material also flows into the space created by the recessed magnetic layer 4 under the floor panel 2 resting on the support 5. After the joint material has cured, additional fastening is created by bonding the floor panel 2 to the support 5. In addition, the cured joint material also adheres to the side edges of the floor panel 2, which are also referred to as flanks, and because of this flank adhesion of a floor panel to the adjacent floor panels, a connection of all floor panels into one large panel is achieved as a result. Adjacent floor panels are then so firmly connected that they do not displace each other and support each other as a result of the flank adhesion.

Particularly preferably, this produces—with or without edge strips 11 on the floor panels 2—a composite of—viewed from bottom to top—leveling layer 6, support 5 and floor panels 2 with magnetic layer 4, whereby the floor panels 2 may be bonded to one another and/or to the support. Furthermore, further adhesive layers 3, 3′ may be provided, as already explained. Such a composite can be laid directly on a floor 7 as a floor covering 1. In this case, it is shown in the case of, for example, ceramic tiles as floor panels 2 that these can thereafter be driven over by a passenger car without any problems and without breaking. Furthermore, further fastening of said composite to the floor 7 is generally not required, and the composite can be removed from the floor very quickly if necessary, namely simply taken down, and put back on again if required.

In FIG. 6, a perspective view of a floor covering 1 laid out in a room 12 is shown, with the dashed lines representing the supports 5 staggered side by side, and the solid lines representing the floor panels 2 lying on top.

The floor panel 2 has the dimensions length 1 and width b, the support 5 has the dimensions length L and width B. The support 5 has larger dimensions L and B than the floor panel 2, and has a surface area that is at least 1.5 times the area of the top of the floor panel 2, in the present case about 2.5 to 3 times.

Adjacent supports 5, in particular adjacent pressure distribution panels, can preferably be equipped with a click system, as is known from tiles. In this way, the supports 5 can be laid very quickly and reversibly in the room 12.

The magnetic layer 4 shown in FIGS. 1 to 5 extends over at least 90% of each of the dimensions length 1 and width b of the underside 2.2 of the floor panel 2 and covers it over part or all of its surface. If the magnetic layer 4 covers the floor panel 2 over only part of its surface area, this can be done in various ways, either contiguously with openings or in individual segments spaced apart or abutting one another. At least a total area of 25% of the underside 2.3 should be covered, preferably at least 50%, and particularly preferably at least 85% of the underside. The greater the coverage, the greater the adhesive force of the magnetic foil 4 on the support 5.

Also, instead of being full-surface and completely covering the leveling layer, the support 5 can be only partial-surface, as shown in FIGS. 1 to 4 and 6. However, the support 5 should cover at least a total area of 50% of the leveling layer 6, preferably at least 70%, and particularly preferably at least 85%.

Since the force of the magnetic attraction of the magnetic connection between the floor panel 2 and the support 5 is so strong that, due to the adhesive force caused by the adhesion between the floor panel 2 and the support 5, subsequent lateral displacement of the floor panel 2 relative to the support 5 is very difficult or even impossible, an assembly aid is provided by means of which a constant joint width can be set.

So-called joint crosses are known from the prior art, which are applied to the corners after laying the first floor panel and specify an alignment of the next floor panel. The joint width is also specified in this process.

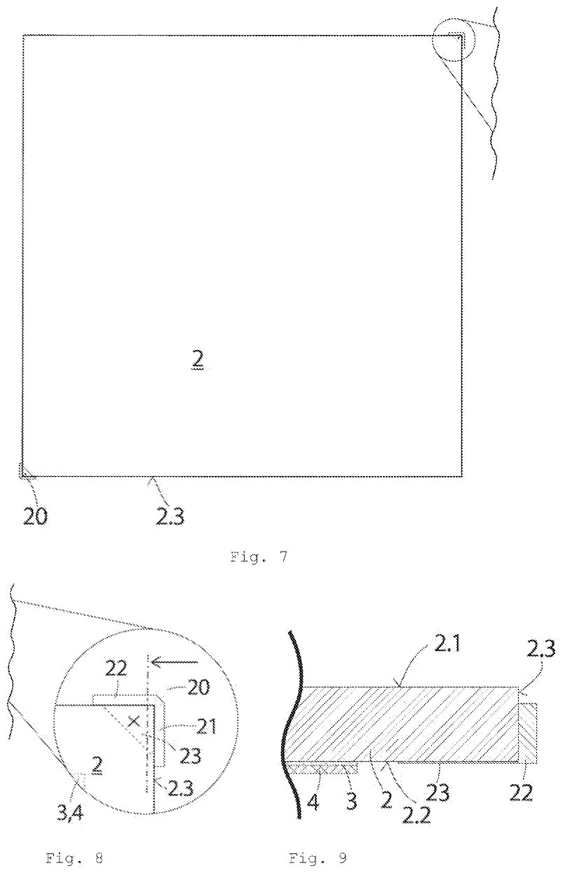

The present invention preferably uses a joint angle 20 shown in FIGS. 7-9, which is preferably arranged at two opposite corners of the floor panel 2, as shown in FIG. 7.

FIG. 8 shows an enlargement of the joint angle 20 attached to the floor panel 2 from FIG. 7. The joint angle 20 has two legs, namely a first leg 21 and a second leg 22, each extending along a side surface 2.3 of the floor panel 2. Below the floor panel 2, a thin support part 23 connected to both legs 21, 22 extends from one leg 21 to the other leg 22 on the underside 2.2 of the floor panel 2, which support part 23 may furthermore be connected to the underside 2.2, for example by adhesive bonding. Alternatively or additionally, the legs 21, 22 can also be connected to the side edge 2.3 of the floor panel 2 by adhesive bonding.

From the section shown in FIG. 9 along the section line of FIG. 8, it can be seen that the leg 22 does not extend over the entire height of the side surface 2.3, but only in part, so that a joint remains between two adjoining base panels 2 which is set back relative to the upper side 2.1 of the base panel and can be closed with a joint adhesive.

### LIST OF REFERENCE SIGNS

1 Flooring
1.1 (Walkable) surface of the floor covering
2 floor panel, tile
2′ base panel
2.1 Top side of the floor panel
2.2 Bottom side of the floor panel
2.3 Side surface of the floor panel
3, 3′, 3″ Adhesive
4 Magnetic layer
5 support
6 Leveling layer
7 Floor
7′ Wall
8 Angle profile
9 Connection profile
9.1 Sealing lip
10 Intermediate space
11 Edge strip
12 Room
20 Joint angle
21 first leg (joint angle)
22 Second leg (joint angle)
23 Support part (joint angle)

1. Floor panel of a floor covering, which forms a surface of the floor covering which can be walked on by laterally placing a plurality of floor panels against one another, wherein the floor panel has the dimensions length and width, and wherein a magnetic layer is arranged on an underside of the floor panel, characterized in that the magnetic layer extends over at least 90% of each of the two dimensions length and width of the underside of the floor panel at least over part of the surface, and covers at least a total area of 85% of the underside and in that the magnetic layer is laterally recessed with respect to a side edge of the floor panel so that there is a distance from the side edge, and the underside of the floor panel is uncovered by the magnetic layer over this distance, wherein the distance of the magnetic layer from the side edge of the floor panel is between 3-10 mm.

2. Floor panel according to claim 1, characterized in that the magnetic layer is full-surface.

3. (canceled)

4. Floor panel according to claim 2, characterized in that the magnetic layer is laterally recessed with respect to each side edge of the floor panel.

5. Floor panel according to claim 4, characterized in that the distance of the magnetic layer from the side edge of the floor panel is about 5 mm.

6. Floor panel according to claim 5, characterized in that the magnetic layer has a thickness of at least 0.5 to at most 3 mm, and has a Shore D hardness according to DIN ISO 7619-1 issue 2-2012 of at least 50 Shore D 3s.

7. Floor panel according to claim 6, characterized in that the magnetic layer is a magnetic foil, that the magnetic foil is magnetic on one side only and in that the magnetic foil is self-adhesive or attached to the underside of the floor panel by means of an adhesive, wherein the non-magnetic side is arranged towards the floor panel.

8. (canceled)

9. Floor panel according to claim 6, characterized in that the magnetic layer is formed from a cured compound which can still be shaped before curing by application to the underside.

10. Floor panel according to claim 9, characterized in that the floor panel is a tile that includes a ceramic tile.

11. Floor covering, comprising a floor panel according to claim 10 and a support on which the floor panel rests, the support comprising a magnetic material which interacts with the magnetic layer of the floor panel, characterized in that the magnetic material of the support is formed by a pressure distribution panel which is connected to a plastically or elastically deformable leveling layer and at least partially covers the latter, wherein the floor covering forms a composite which, with its leveling layer, can be placed directly on a floor and can be removed from it again.

12. Floor covering according to claim 11, characterized in that the pressure distribution panel is or comprises an at least partial-surface magnetic sheet.

13. Floor covering according to claim 12, characterized in that the pressure distribution panel comprises a plate of plastic or cement fiber, a high-density fiberboard (HDF), a medium-density fiberboard (MDF), or a combination or composite of at least two thereof.

14. Floor covering according to claim 13, characterized in that the pressure distribution panel covers at least a total area of 50% of the leveling layer, or at least 70%, or at least 85%.

15. Floor covering according to claim 14, characterized in that the pressure distribution panel is full-surface and completely covers the leveling layer.

16. Floor covering according to claim 15, characterized in that the leveling layer is bonded to the pressure distribution panel by means of an adhesive.

17. Floor covering according to claim 16, characterized in that the support has an area which is at least 1.5 times the area of the upper side of the floor panel.

18. (canceled)

19. Floor covering according to claim 15, characterized in that adjacent supports are connected to each other via a click system.

20. Floor covering according to claim 19, characterized by an angle profile which projects below the leveling layer and is connected, via an adhesive, to a wall extending upwards over the floor.

21. Floor covering according to claim 20, characterized in that the angle profile is at least partially magnetic, and that a base panel is attached to the wall via a magnetic foil fixed by means of an adhesive.

22. Floor covering according to claim 21, characterized by a connecting profile in the form of an inverted letter T, which is introduced between two adjacently arranged floor panels.

23. Floor covering according to claim 22, characterized in that, with respect to the shape of the connecting profile, sealing lips are arranged at the ends of the transverse bar of the inverted letter T, and these seal a joint between two adjacent floor panels.

24. Floor covering according to claim 23, characterized in that a joint angle is arranged at each of two opposing corners of a floor panel, which joint angle has a first leg and a second leg, each of which extends along a side surface of the floor panel.

25. Floor covering according to claim 241, characterized in that the joint angle on the underside of the floor panel has a thin support part which extends between the first leg and the second leg.

26. Floor covering according to claim 25, characterized in that the legs do not extend over the entire height of the side surface of the floor panel, so that between two adjoining floor panels there remains a joint which is set back relative to the upper side of the floor panel.
